(19) United States
(12) Patent Application Publication
(10) Pub. No.: US 2014/0021266 A1
(43) Pub. Date: Jan. 23, 2014

(54) SERVOMECHANISM CONTROL FOR NON-LINEAR SYSTEMS

(71) Applicants: Fco Javier Pérez Gellida, Sant Cugat (Barcelona) (ES); Mikel Zuza Irurueta, Barcelona (ES); Oriol Borrell Avila, Sabadell (ES)

(72) Inventors: Fco Javier Pérez Gellida, Sant Cugat (Barcelona) (ES); Mikel Zuza Irurueta, Barcelona (ES); Oriol Borrell Avila, Sabadell (ES)

(21) Appl. No.: 13/555,890

(22) Filed: Jul. 23, 2012

(51) Int. Cl. G05D 23/02

(52) U.S. Cl. 236/101 R

(57) ABSTRACT

Controlling a temperature with a servomechanism. A temperature is monitored at the servomechanism for a period of time. A difference is determined between the temperature and a target temperature at the servomechanism. A target power gain is determined at the servomechanism to produce the target temperature such that the target power gain is determined based on a non-linear determination. A power gain is adjusted at the servomechanism to the target power gain based on a result of the determination such that the temperature is the target temperature.

### BACKGROUND

Servomechanisms (servos) are automatic devices that use error-sensing negative feedback to correct the performance of a device. Servos are commonly used to control position, speed, and temperature. Any difference between an actual value and a wanted value is amplified, converted, and used to drive a system in the direction necessary to reduce or eliminate the difference.

### BRIEF DESCRIPTION OF THE DRAWINGS

The accompanying drawings, which are incorporated in and form a part of this specification, illustrate and serve to explain the principles of examples in conjunction with the description. Unless specifically noted, the drawings referred to in this description should be understood as not being drawn to scale.

FIG. 1 shows an example block diagram upon which examples of the present invention may be implemented.

FIG. 2 shows an example system upon which examples of the present invention may be implemented.

FIG. 3 is example flowchart of controlling a temperature with a servomechanism in accordance with examples of the present invention.

FIG. 4 is example flowchart of controlling a temperature with a servomechanism in accordance with examples of the present invention.

FIG. 5 is a block diagram of an example system used in accordance with one example of the present invention.

### DESCRIPTION OF EXAMPLES

Reference will now be made in detail to various examples, examples of which are illustrated in the accompanying drawings. While the subject matter will be described in conjunction with these examples, it will be understood that they are not intended to limit the subject matter to these examples. Furthermore, in the following description, numerous specific details are set forth in order to provide a thorough understanding of the subject matter. In other instances, well-known methods, procedures, objects, and circuits have not been described in detail as not to unnecessarily obscure aspects of the subject matter.

### Notation and Nomenclature

Some portions of the description of examples which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present discussions terms such as “monitoring”, “determining”, “adjusting”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Furthermore, in some examples, methods described herein can be carried out by a computer-usable storage medium having instructions embodied therein that when executed cause a computer system to perform the methods described herein.

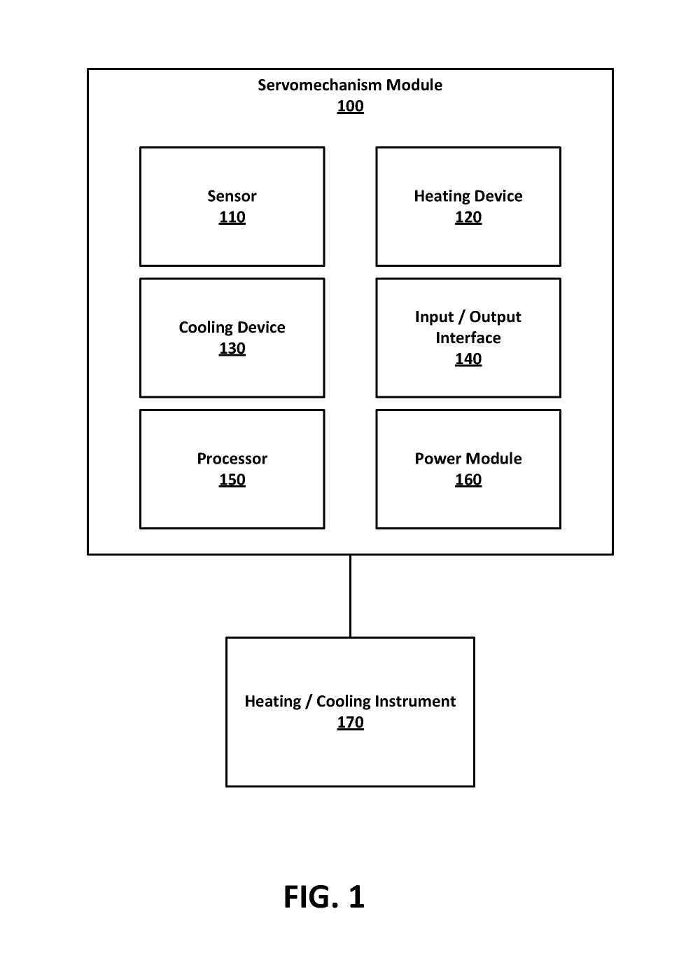

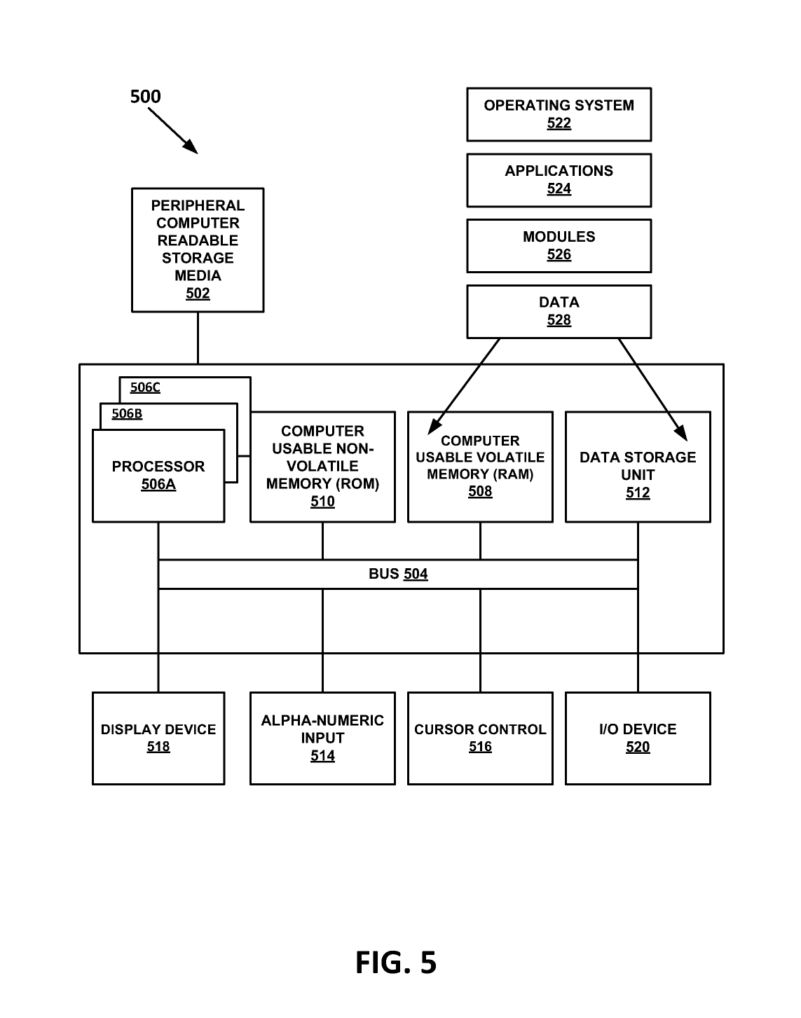

FIG. 1 shows a servomechanism module (servo) 100. In an example, servo 100 can accurately set and/or maintain a temperature in any condition. No universal constant is required because servo 100 is self-adaptive. In some examples, servo 100 comprises a sensor 110, a heating device 120, a cooling device 130, an input/output (I/O) interface 140, a processor 150, and a power module 160. It should be noted that while FIG. 1 shows various devices within servo 100, these devices may be external from servo 100. For example, various sensors 110, heating devices 120 and cooling devices 130 may be remote from servo 100. In such a case the devices are communicatively coupled to servo 100. In some examples, system 500 of FIG. 5, or portions thereof is located within servo 100.

In some examples, servo 100 is coupled with heating/cooling instrument 170. Heating/cooling instrument 170 may include, but is not limited to: an oven, batch ovens, conveyor ovens, refrigerators, curing devices, a plurality of resistors, etc. In some examples, servo 100 controls the temperature within heating/cooling instrument 170 using procedures described herein. In some examples servo 100 is communicatively coupled to heating/cooling instrument 170. In some examples, a servo 100 is coupled, communicatively or otherwise, to a plurality of heating/cooling instruments 170. In some examples servo 100 is installed within heating/cooling instrument 170, while in other examples servo 100 is remote from heating/cooling instrument 170. In some examples, some of the modules (e.g., sensor 110, heating device 120, cooling device 130, I/O interface 140, etc.) are located within servo 100, while some of the modules are located within heating/cooling instrument 170.

Servo 100 comprises a sensor 110. In some examples sensor 110 may be a single sensor 110, while in other examples it may comprise multiple sensors 110. Sensor 110 may include, but is not limited to: temperature sensors, voltage sensors, current sensors, pulse-width modulation sensors, resistive sensors, pressure sensors, noise sensors, tachometers, heat coils, etc. In some examples sensors are required to provide feedback to servo 100 such that the device (e.g., heating/cooling instrument 170) in which servo 100 is implemented may reach the correct temperature. In some examples the servo 100 comprises air-flow sensors such that the servo 100 can make adjustments based on the air-flow within heating/cooling instrument 170. In some examples many air-flow conditions exist which servo 100 can differentiate and then adjust itself accordingly.

In some examples servo 100 comprises heating device 120. In some examples heating device 120 may comprise a single heating device 120, or a plurality of heating devices 120. In some examples heating devices 120 are connected to each other or to a processor 150 with single or bi-directional busses. Heating devices 120 may include any type of heating device 120 commonly used in heating/cooling instruments 170 as will be discussed herein. In some examples convection heating is employed, and in some examples infrared heating is employed. In some examples, a heating device 120 may transfer anywhere from 50 to over 50,000 Btu/hr-ft², for example. In some examples heating device 120 may generate heat from the combustion of a gas (e.g., at a stoichiometric mixture). In some examples heating device 120 may use electricity.

In some examples servo 100 comprises cooling device 130. In some examples there is only one cooling device 130 while in other examples there are a plurality of cooling devices 130. In some examples cooling devices 130 are connected to each other or to a processor 150 with single or bi-directional busses. In some examples cooling device 130 employs liquid cooling, air cooling, heat sinks, thermoelectric cooling, phase-change cooling, or solid state cooling. All of these cooling devices 130 are well known in the art and will not be discussed for the sake of brevity.

In some examples servo 100 comprises an I/O interface 140. In some examples I/O interface 140 is used to program servo 100. In other examples I/O device 520 (of FIG. 5) is used instead of or in conjunction with I/O interface 140. For the purposes of this disclosure the references to I/O interface 140 and I/O device 520 are interchangeable. In some examples I/O interface 140 provides a user or a system with an interface to enter parameters. In some examples parameters include a target temperature, a derivative constant, an integral constant, and/or a proportional constant.

In some examples servo 100 comprises a processor 150. In some examples processor 150 performs operations to control servo 100. In some examples processor 150 is used in conjunction with processor 506 (of FIG. 5). In some examples only one processor 150/506 is present. In some examples servo 100 may comprise a plurality of processors. In some examples a bus interface such as the Inter-IC (I2C) bus interface is in communication with processor 150 such that each individual device utilizing the I2C bus may be interconnected. In some examples other bus interface systems and protocols may be used including the controller-area network (CAN) protocol.

In some examples servo 100 comprises a power module 160. In some examples power module 160 is used to provide power to the devices within servo 100 including heating device 120 and cooling device 130. In some examples, power module 160 may control the speed of fans coupled with servo 100. In some examples power module 160 controls the power gain of the servo 100.

It should be noted that in some examples several controls are based on a proportional response to the input. For example, the proportional response between the temperature and the power may not be linear. In other words, a fixed amount of power does not necessarily raise the temperature by a fixed amount.

When a heating/cooling instrument 170, such as an oven or curing instrument, needs to reach a target temperature either a heating device 120 or a cooling device 130 may be used to assist in reaching the target temperature. In some examples, heating/cooling instrument 170 merely needs to maintain a temperature rather than change the temperature to a target temperature. Often times when a heating/cooling instrument 170 is powered on the temperature inside the heating/cooling instrument 170 is very cold (or hot, depending on the instrument 170 and situation). As the temperature increases, less power is needed to heat the device. When the temperature passes the target temperature, power is reduced or another heating device 120 or cooling device 130 is employed such that the temperature returns to the target temperature. This process of reaching the target temperature may require several iterations and often uses a servo 100 that employs error-sensing negative feedback to correct the temperature of the device.

In some examples, servo 100 provides advantages including disturbance rejection, guaranteed performance when parameters are incorrect, stabilization of unstable processes, reduction of sensitivity to parameter variations, improvement of reference tracking performance, etc.

Servo 100 operates by comparing a temperature to a target temperature. In some examples this comparison is performed by a transducer. In some examples, any difference between the temperature and the target temperature is an error signal, which is then amplified and converted, and then used to drive the temperature in the direction necessary to reduce or eliminate the error.

In one example, equation 1 may be used such that servo 100 causes a system to reach a target temperature.

$${P}_{in} = {P}_{Steady} + {K}_{p} err ( T ) + {K}_{d} \frac{d T}{d t} \qquad ( Equation 1 )$$

In equation 1 Pᵢₙ is an input power, P_{Steady} is a long term power consumption the system requires to keep a target temperature, Kₚ is a proportional constant, err is the difference between the temperature and the target temperature, T is the temperature, K_{d} is a derivative constant, and t is time.

In some examples, a non-linear term is used to determine an input power. In some examples an integral term is used in place of P_{Steady}, thus creating a PID (proportional-integral-derivative) implementation, or a PID controller. In an example, where an integral term is used, the relative weight of the integral term in a PID implementation is fixed.

A PID controller is a generic control loop feedback mechanism used in industrial control systems. A PID controller calculates an error value as the difference between a measured process variable and a target point. A PID controller attempts to minimize error by adjusting process control inputs.

A PID controller determination involves three separate parameters including the proportional, integral and derivative values.

In some examples, the P value depends on the present error. The P value produces an output value that is proportional to the current error value. The proportional response can be adjusted by multiplying the error by a constant Kₚ called the proportional gain constant.

In some examples, the proportional term is given by the equation:

Pₒᵤₜ=Kₚerr(t) (Equation 2)

where t is time, and Pₒᵤₜ is the P value. A high proportional gain results in a large change in the output for a given change in the error. If the proportional gain is too high, the system can become unstable. A small P value may result in a response to system disturbances because the P value is too small to sufficiently correct errors.

In some examples the I value is proportional to both the magnitude of the error and the duration of the error. In some examples the I value is the sum of the instantaneous error over time and gives the accumulated offset that should have been corrected previously. In some examples the accumulated error is then multiplied by the integral gain Kᵢ and added to the controller output.

In some examples, the integral term is given by the equation:

Iₒᵤₜ=Kᵢ∫₀^{t}err(t)dt (Equation 3)

In some examples the integral term accelerates the movement of the process towards a target point and eliminates the residual steady-state error that occurs with a pure proportional controller.

In some examples the D value is calculated by determining the slope of the error over time and multiplying this rate of change by the derivative gain K_{d}.

In some examples, the derivative term is given by the equation:

$${D}_{out} = {K}_{d} \frac{d}{d t} err ( t ) \qquad ( Equation 4 )$$

The derivative term slows the rate of change of the controller output. In some examples derivative control is used to reduce the magnitude of the overshoot produced by the integral component and improve the combined controller-process stability. The derivative term also slows the transient response of the controller. Also, differentiation of a signal amplifies noise and thus this term in the controller is highly sensitive to noise in the error term, and can cause a process to become unstable if the noise and the derivative gain are sufficiently large. In some examples an approximation to a differentiator with a limited bandwidth is used.

In some examples a weighted sum of the P, I and D values is used to adjust the power gain, thereby adjusting the temperature. In some examples a PID controller can provide control for specific process requirements. In such cases parameters are entered such that the servo 100 causes a system to reach a target temperature.

In one example, a moving integral average which may be responsible for the self-adjustment of the power gain is used as a substitution for P_{Steady} as shown below in equation 5.

$${P}_{in} ( t ) = \frac{{P}_{in} ( t - Δ t )}{{T}_{Target} ( Δ t )} {\int }_{t - Δ t}^{t} T ( t ) d t + {K}_{p} err ( T ) + {K}_{d} \frac{d T}{d t} \qquad ( Equation 5 )$$

Where T_{Target} is a target temperature and Δt is a period of time.

In an example, equation 5 causes servo 100 to constantly determine the amount of power required to keep the average temperature at the target temperature. In an example, the proportional and derivative terms quickly seed the servo 100 equation and improve the response when the target temperature is relatively far from the temperature. Once the temperature is closer to the target temperature, the self-adjusted term becomes the dominant term in the power balance as the proportional and derivative errors become smaller. This assures better servo 100 stability. This is true regardless of the air-flow and the target temperature range, and results in almost no overshoot. Moreover, the self-adjusted term improves compliance with the regulatory limit of maximum acceptable power variation over time. For example, flickers may be reduced and line voltage oscillations may be smaller. In one example, the power gain is adjusted based on the amount of air-flow. In one example, the power gain is adjusted based on the temperature of intake air.

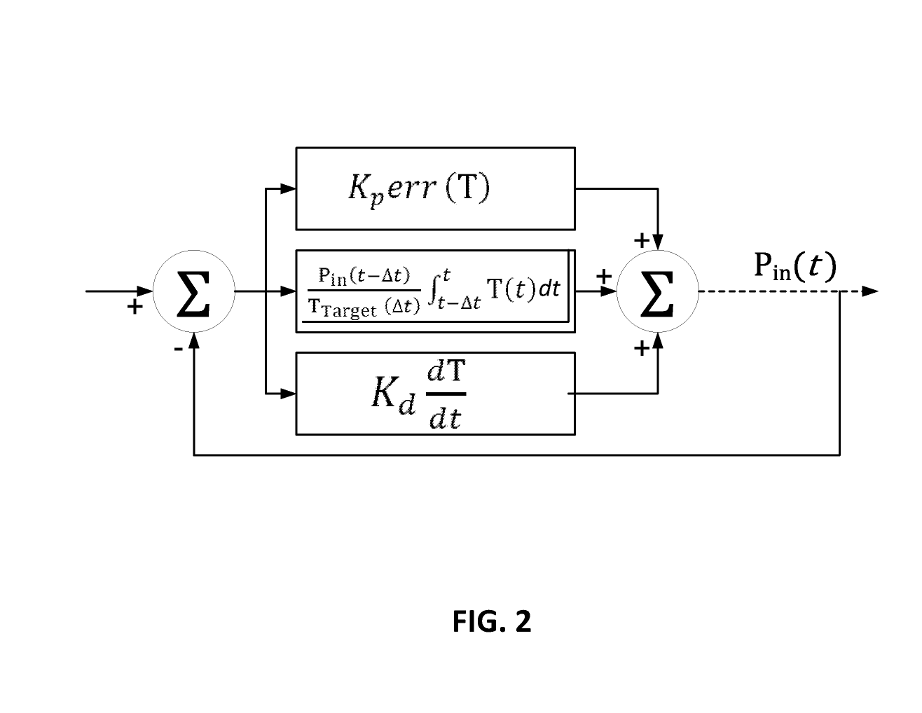

FIG. 2 shows an example control loop comprising equation 5. FIG. 2 shows each term from equation 5 wherein an output is a power gain at a given time, which is then fed back into the loop. In addition to the current power entering the system, the temperature and target temperatures are fed into the system. In one example the servo 100 is constantly checking the average temperature. In an example the servo 100 will self-adjust because the integral average term will be compared to the average consumption for a period of time. In an example accurate constants do not need to be selected in advance. In some examples this occurs in an iterative fashion.

### Example Methods of Use

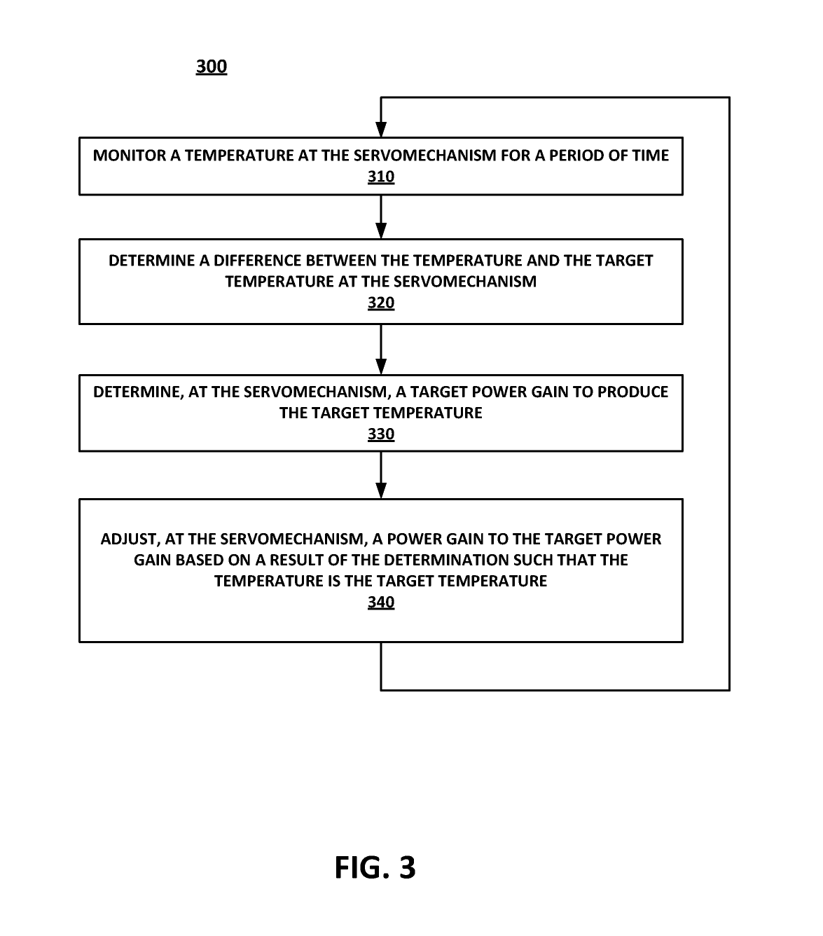

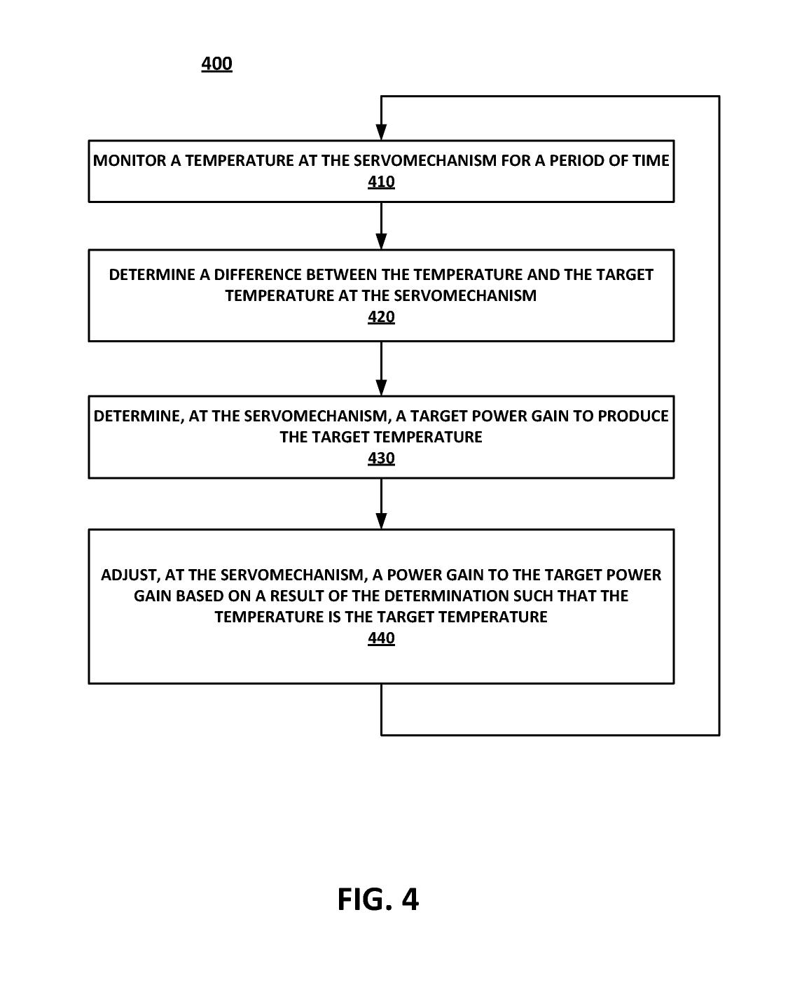

The following discussion sets forth in detail the operation of some example methods of operation of examples. FIGS. 3 and 4 illustrate example procedures used by various examples. Flow diagrams 300 and 400 include some procedures that, in various examples, are carried out by one or more of the electronic devices illustrated in FIG. 1, FIG. 5, or a processor under the control of computer-readable and computer-executable instructions. In this fashion, procedures described herein and in conjunction with flow diagrams 300 and 400 are or may be implemented using a computer, in various examples. The computer-readable and computer-executable instructions can reside in any tangible computer readable storage media, such as, for example, in data storage features such as RAM 508, ROM 510, and/or storage device 512 (all of FIG. 5). The computer-readable and computer-executable instructions, which reside on tangible computer readable storage media, are used to control or operate in conjunction with, for example, one or some combination of processor 506A, or other similar processor(s) 506B and 506C. Although specific procedures are disclosed in flow diagrams 300 and 400, such procedures are examples. That is, examples are well suited to performing various other procedures or variations of the procedures recited in flow diagrams 300 and 400. Likewise, in some examples, the procedures in flow diagrams 300 and 400 may be performed in an order different than presented and/or not all of the procedures described in one or more of these flow diagrams may be performed, and/or one or more additional operations may be added. It is further appreciated that procedures described in flow diagrams 300 and 400 may be implemented in hardware, or a combination of hardware, with either or both of firmware and software.

FIG. 3 is a flow diagram 300 of an example method of controlling a temperature with a servomechanism 100 in accordance with one example.

In operation 310, in one example, the servo 100 monitors a temperature for a period of time. In some examples the period of time is less than a second, while in other examples the period of time can be for much more than a second. In some examples an average temperature is measured. In other examples an instantaneous temperature is measured.

In operation 320, in one example, servo 100 determines a difference between the temperature and the target temperature. As discussed herein, servo 100 receives the current temperature and a target temperature and determines the difference between the two. In some examples a PID implementation is employed within the servo 100 such as in equation 5 to assist the servo 100 in changing the temperature to the target temperature.

In operation 330, in one example, the servo 100 determines a target power gain to produce the target temperature. After servo 100 determines the difference between the temperature and a target temperature, and determines the current power gain, servo 100 determines the power gain required such that the temperature reaches the target temperature.

In operation 340, the servo 100 adjusts a power gain to the target power gain based on a result of the determination made in operation 330 such that the temperature is equal to the target temperature. In some examples, once the temperature is equal to the target temperature the process is repeated. In some examples the process will not be repeated if the power to the servo 100 is shut off or the servo 100 is no longer needed for some other reason.

FIG. 4 is a flow diagram 400 of an example method of controlling a temperature with a servomechanism 100 in accordance with one example.

In operation 410, in one example, the servo 100 monitors a temperature for a period of time. In some examples the period of time is less than a second, while in other examples the period of time can be for much more than a second. In some examples an average temperature is taken. In other examples an instantaneous temperature is taken.

In operation 420, in one example, servo 100 determines a difference between the temperature and the target temperature. As discussed herein, servo 100 receives the current temperature and a target temperature and determines the difference between the two. In some examples a PID implementation is employed within the servo 100 such as in equation 5 to assist the servo 100 in changing the temperature to the target temperature.

In operation 430, in one example, the servo 100 determines a target power gain to produce the target temperature. After determining the difference between the temperature and a target temperature, and determining the current power gain, the servo 100 determines the power gain required such that the temperature reaches the target temperature.

In operation 440, the servo 100 adjusts a power gain to the target power gain based on a result of the determination made in operation 330 such that the temperature is equal to the target temperature. In some examples, once the temperature is equal to the target temperature the process is repeated. In some examples the process will not be repeated if the power to the servo 100 is shut off or the servo 100 is no longer needed for some other reason.

### Example Electronic Environment

With reference now to FIG. 5, all or portions of some examples described herein are composed of computer-readable and computer-executable instructions that reside, for example, in computer-usable/computer-readable storage media of a computer system. That is, FIG. 5 illustrates one example of a type of computer (computer system 500) that can be used in accordance with or to implement various examples which are discussed herein. It is appreciated that computer system 500 of FIG. 5 is an example and that examples as described herein can operate on or within a number of different computer systems including, but not limited to, general purpose networked computer systems, embedded computer systems, routers, switches, server devices, client devices, various intermediate devices/nodes, stand alone computer systems, media centers, handheld computer systems, multi-media devices, and the like. In one example, computer system 500 may be implemented in a servomechanism module 100 illustrated in FIG. 1. Computer system 500 of FIG. 5 is well adapted to having peripheral tangible computer-readable storage media 502 such as, for example, a floppy disk, a compact disc, digital versatile disc, other disc based storage, universal serial bus “thumb” drive, removable memory card, and the like coupled thereto. The tangible computer-readable storage media is non-transitory in nature.

System 500 of FIG. 5 includes an address/data bus 504 for communicating information, and a processor 506A/150 coupled with bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g., random access memory (RAM), coupled with bus 504 for storing information and instructions for processors 506A, 506B, and 506C. System 500 also includes computer usable non-volatile memory 510, e.g., read only memory (ROM), coupled with bus 504 for storing static information and instructions for processors 506A, 506B, and 506C. Also present in system 500 is a data storage unit 512 (e.g., a magnetic or optical disk and disk drive) coupled with bus 504 for storing information and instructions. System 500 may also include an alphanumeric input device 514 including alphanumeric and function keys coupled with bus 504 for communicating information and command selections to processor 506A or processors 506A, 506B, and 506C. System 500 may also include cursor control device 516 coupled with bus 504 for communicating user input information and command selections to processor 506A, processor 150, or processors 506A, 506B, and 506C. In one example, system 500 may also include display device 518 coupled with bus 504 for displaying information.

Referring still to FIG. 5, display device 518 of FIG. 5, when included, may be a liquid crystal device, cathode ray tube, plasma display device or other display device suitable for creating graphic images and alphanumeric characters recognizable to a user. Cursor control device 516, when included, allows the computer user to dynamically signal the movement of a visible symbol (cursor) on a display screen of display device 518 and indicate user selections of selectable items displayed on display device 518. Many implementations of cursor control device 516 are known in the art including a trackball, mouse, touch pad, joystick or special keys on alphanumeric input device 514 capable of signaling movement of a given direction or manner of displacement. Alternatively, it will be appreciated that a cursor can be directed and/or activated via input from alphanumeric input device 514 using special keys and key sequence commands. System 500 is also well suited to having a cursor directed by other means such as, for example, voice commands. System 500 also includes an I/O device 520, or 140, for coupling system 500 with external entities. For example, in one example, I/O device 520 is a modem for enabling wired or wireless communications between system 500 and an external network such as, but not limited to, the Internet. In other examples I/O device 520 may receive parameters for servo 100.

Referring still to FIG. 5, various other components are depicted for system 500. Specifically, when present, an operating system 522, applications 524, modules 526, and data 528 are shown as typically residing in one or some combination of computer usable volatile memory 508 (e.g., RAM), computer usable non-volatile memory 510 (e.g., ROM), and data storage unit 512. In some examples, all or portions of various examples described herein are stored, for example, as an application 524 and/or module 526 in memory locations within RAM 508, computer-readable storage media within data storage unit 512, peripheral computer-readable storage media 502, and/or other tangible computer-readable storage media.

Examples of the present technology are thus described. While the present technology has been described in particular examples, it should be appreciated that the present technology should not be construed as limited by such examples, but rather construed according to the following claims.

What is claimed is:

1. A method for controlling a temperature with a servomechanism, said method comprising:
monitoring a temperature at said servomechanism for a period of time;
determining a difference between said temperature and a target temperature at said servomechanism;
determining, at said servomechanism, a target power gain to produce said target temperature wherein the target power gain is determined based on a non-linear determination; and
adjusting, at said servomechanism, a power gain to said target power gain based on a result of said determination such that said temperature is said target temperature.

2. The method of claim 1 wherein said non-linear determination comprises:
a defined proportional value;
a defined derivative value; and
an undefined moving integral average value.

3. The method of claim 2 wherein a proportion of said undefined moving integral average value relative to said defined proportional value and said defined derivative value is not fixed.

4. The method of claim 2 wherein said undefined moving integral average value becomes a dominant term relative to said defined proportional value and said defined derivative value as an amount of time increases.

5. The method of claim 2 wherein said undefined moving integral average value is self-adaptive.

6. The method of claim 1 wherein said adjusting of said power gain compensates for changes in the amount of airflow.

7. The method of claim 1 wherein said adjusting of said power gain causes a heating device to increase said temperature.

8. A servomechanism comprising:
a temperature sensor to sense a temperature;
at least one temperature adjusting device to adjust said temperature;
a motor to power to power said temperature adjusting device; and
an adaptive power control to provide an adjustable amount of power gain to said motor to adjust said temperature to a target temperature by adjusting a power gain to a target power gain, wherein said target power gain is determined by:
monitoring said temperature at said servomechanism for a period of time;
determining a difference between said temperature and said target temperature; and
determining said target power gain to produce said target temperature wherein a determination to produce said target power gain is based on a non-linear determination.

9. The servomechanism of claim 8 wherein said non-linear determination comprises:
a defined proportional value;
a defined derivative value; and
an undefined moving integral average value.

10. The servomechanism of claim 9 wherein a proportion of said undefined moving integral average value relative to said defined proportional value and said defined derivative value is not fixed.

11. The servomechanism of claim 9 wherein said undefined moving integral average value is self-adaptive.

12. The servomechanism of claim 8 wherein said adjusting of said power gain compensates for intake air temperature.

13. The servomechanism of claim 8 wherein said adjusting of said power gain causes a heating device to increase said temperature.

14. The servomechanism of claim 8 wherein said power gain is compliant with a regulatory limit of maximum acceptable power variation over time.

15. A computer-usable storage medium having instructions embodied therein that when executed cause a computer system to perform a method for controlling a temperature with a servomechanism, said method comprising:
monitoring a temperature at said servomechanism for a period of time;
determining a difference between said temperature and a target temperature at said servomechanism;
determining, at said servomechanism, a target power gain to produce said target temperature wherein the target power gain is determined based on a non-linear determination; and
adjusting, at said servomechanism, said power gain to said target power gain based on a result of said determination such that said temperature changes to said target temperature.

16. The computer-usable storage medium of claim 15 wherein said non-linear determination comprises:
a defined proportional value;
a defined derivative value; and
an undefined moving integral average value.

17. The computer-usable storage medium of claim 16 wherein said undefined moving integral average value is self-adaptive.

18. The computer-usable storage medium of claim 16 wherein a proportion of said undefined moving integral average value relative to said defined proportional value and said defined derivative value is not fixed.

19. The computer-usable storage medium of claim 15 wherein said adjusting of said power gain causes a change in an airflow.

20. The computer-usable storage medium of claim 15 wherein said adjusting of said power gain causes a heater to increase said temperature.
